(19) United States
(12) Patent Application Publication
(10) Pub. No.: US 2005/0264855 A1
(43) Pub. Date: Dec. 1, 2005

(54) Scanning apparatus provided with a gear system for changing rotation speed of a toothed belt

(75) Inventors: Chia-Tsui Lan, TaoYuan Hsien (TW); Ping-Hung Kuo, Taipei (TW)

Correspondence Address: BRUCE H. TROXELL;SUITE 1404, 5205 LEESBURG PIKE, FALLS CHURCH, VA, 22041, US

(73) Assignee: Primax Electronics, Ltd.

(21) Appl. No.: 10/968,007

(22) Filed: Oct. 20, 2004

(30) Foreign Application Priority Data
May 28, 2004 (TW) 93115356

(51) Int. Cl. F16H 3/34

(52) U.S. Cl. 358/486

(57) ABSTRACT

A scanning apparatus includes: a toothed belt; a driving member; a first gear set including a first gear trained by the toothed belt; a second gear set spaced apart from the first gear set, and including a second gear trained by the toothed belt; and a switch gear unit including a movable transmission gear driven by the driving member upon actuation thereof, and disposed between the first and second gears. The transmission gear is movable between a first position, in which the transmission gear meshes with the first gear to provide a first rotation speed of the toothed belt, and a second position, in which the transmission gear meshes with the second gear to provide a second rotation speed of the toothed belt different from the first rotation speed.

### FIELD OF THE INVENTION

The invention relates to a scanning apparatus, more particularly to a scanning apparatus provided with a gear system for changing rotation speed of a toothed belt, which carries a scanning module.

### BACKGROUND OF THE INVENTION

A gear system is generally used where the rotation speed of something is required to change. A conventional scanning apparatus includes a scanning module which can scan an image disposed on a scanning surface (a glass substrate) and stores the data as an electronic file. The images to be scanned may have different pixel resolutions. In order to complement the pixel resolutions of the images to be scanned, the scanning module is moved at different speed. In the prior art, the rotation speed of a driving member in the conventional scanning apparatus is adjusted in order to vary the moving speed of the scanning module. However, the torque provided by the driving member is restricted within a predetermined range such that after adjustment the driving member is unable to provide sufficient torque. Replacing a new driving member can result in extra expense, thereby inconvenient to the user of the conventional scanning apparatus.

As illustrated in FIG. 1, a gear system 110 is provided between the driving member 106 and a toothed belt 104 of the conventional scanning apparatus 10 so as to overcome the aforesaid insufficient torque problem. The scanning module 102 is fixed on the toothed belt 104 for co-movable therewith. The toothed belt 104 is trained on a transmission wheel 116. The gear system 110 generally includes first and second gear sets 112, 114 respectively meshed with the transmission wheel 116 and a switch gear 118. The driving member 106 has an output shaft and a driving wheel 108 mounted co-axially on the output shaft and meshed with the switch gear 118. The switch gear 118 is movable between a first position, in which, the switch gear 118 meshes with the first gear set 112 (see FIG. 1) so as to provide a first rotation speed of the toothed belt 104 upon actuation of the driving member 106, and a second position, in which, the switch gear 118 meshes with the second gear set 114 so as to provide a second rotation speed of the toothed belt 104 different from the first rotation speed.

One disadvantage resulting from the use of the conventional scanning apparatus resides in that though the toothed belt 104 (hence the scanning module 102) can achieve the required rotation speed after changing to a selected one of the positions, undesired noise is generated by virtue of idle rotation of the other gear set being meshed with the transmission wheel 116.

### SUMMARY OF THE INVENTION

Therefore, it is the object of the present invention is to provide an image scanning apparatus having a gear system for changing rotation speed of a toothed belt which carries a scanning module. The scanning apparatus of the present invention generates little noise when the toothed belt achieves the required rotation speed.

According to the present invention, a scanning apparatus is provided and includes: a toothed belt; a scanning module mounted on the belt for co-movable therewith; a driving member; a first gear set including a first gear trained by the toothed belt; a second gear set spaced apart from the first gear set, and including a second gear trained by the toothed belt; and a switch gear unit including a movable transmission gear driven by the driving member upon actuation thereof, and disposed between the first and second gears. The transmission gear is movable between a first position, in which the transmission gear meshes with the first gear to provide a first rotation speed of the toothed belt, and a second position, in which the transmission gear meshes with the second gear to provide a second rotation speed of the toothed belt different from the first rotation speed.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view, illustrating how a gear system interconnect a driving member and a toothed belt of a conventional scanning apparatus;

FIG. 2 is a block diagram of the first embodiment of a scanning apparatus of the present invention, illustrating how a gear system interconnects a toothed belt and a driving member of the first embodiment;

FIG. 3 shows how a switch gear unit changes between two positions to selectively mesh with a respective gear set in the first embodiment of FIG. 2; and

FIG. 4 is a side view, illustrating how a modified gear system interconnects a toothed belt and a driving member of the second embodiment of the scanning apparatus according to the present invention.

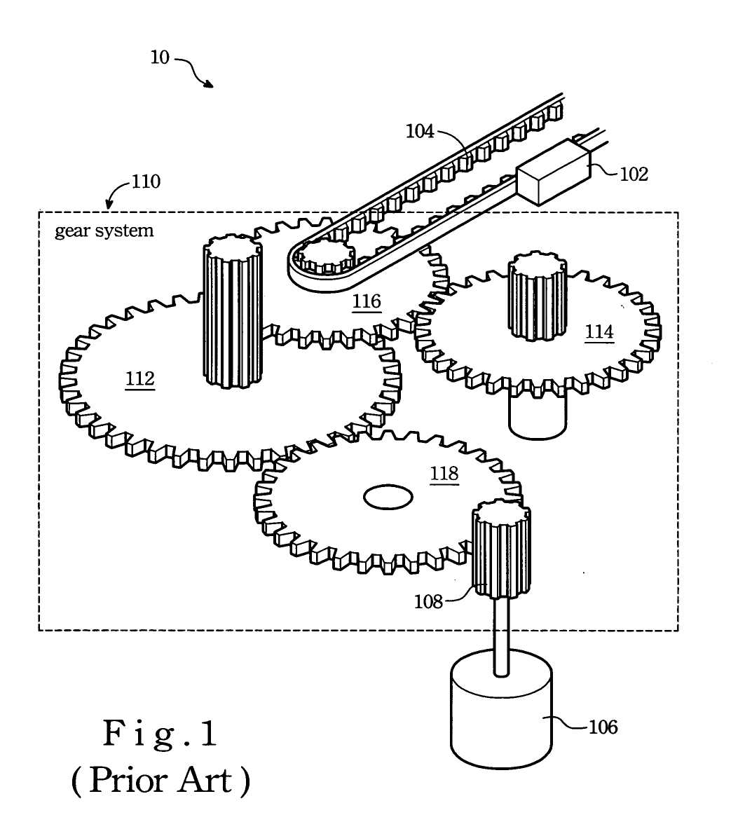

### DETAILED DESCCRIPTIONS OF THE PREFERRED EMBODIMENTS

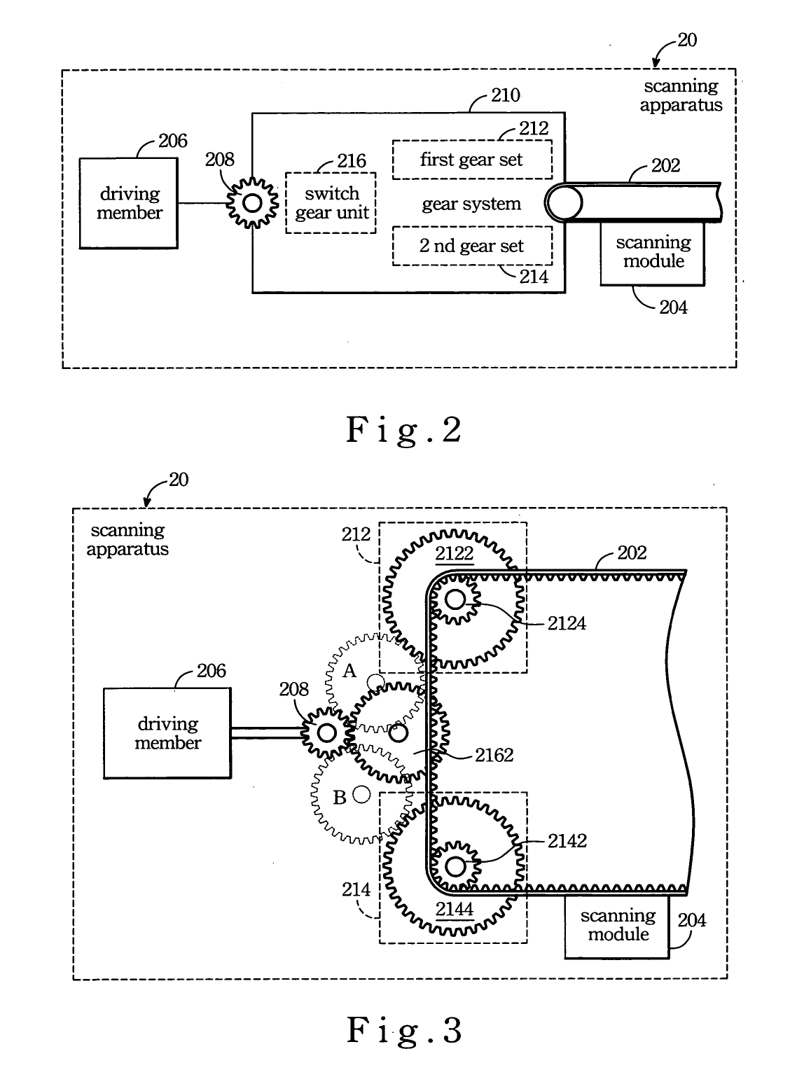

Referring to FIGS. 2 and 3, the first embodiment of an image scanning apparatus 20 of the present invention is shown to include a driving member 206, a toothed belt 202, a scanning module 204 fixed on the toothed belt 202 for co-movable therewith, and a gear system 210.

As illustrated, the gear system 210 includes a first gear set 212, a second gear set 214 spaced apart from the first,gear set 212, and a switch gear unit 216. The first gear set 212 includes a first gear 2124 trained by the toothed belt 202. The second gear set 214 includes a second gear 2142 trained by the toothed belt 202. The switch gear unit 216 includes a movable transmission gear 2162 that is disposed between the first and second gears 2124, 2142 and that is movable between a first position A, in which the transmission gear 2162 meshes with the first gear 2124 to provide a first rotation speed of the toothed belt 202, and a second position B, in which the transmission gear 2162 meshes with the second gear 2142 to provide a second rotation speed of the toothed belt 202 different from the first rotation speed. When the scanning module 204 is moved at the first rotation speed, it can scan the image under the rate of 600 DIP (dot per inch). In the same manner, when the scanning module 204 is moved at the second rotation speed, it can scan the image under the rate of 1200 DIP. The scanning module 204 preferably includes a charge coupled device (CCD) or a contact image scanner (CIS).

The driving member 206 employed in the first embodiment is a stepper motor having an output shaft. The switch gear unit 216 further includes a driving gear 208 that is coupled co-axially to the output shaft of the stepper motor and that is meshed with the transmission gear 2162 so as to transfer the rotation of the stepper motor to a selective one of the gear seats 212, 214, thereby driving the toothed belt 202 upon actuation of the stepper motor. Note that the first and second gear sets 212, 214 further include speed-reducing gears 2122, 2144 of different gear ratio, which are respectively, and co-axially connected to the first and second gears 2124, 2142. The transmission gear 2162 meshes selectively the speed-reducing gears 2122, 2144 at the first and second positions A, B to provide the first and second rotation speed of the toothed belt 202. Note that little noise will be generated during the scanning operation since the transmission gear 2162 meshes a selected gear only. In addition, if the user desires to increase or decrease the torque of the stepper motor, the transmission gear 2162 is moved to a selected one of the positions so as to achieve the required torque, thereby prolonging the service life of the stepper motor, hence the scanning apparatus of the present invention.

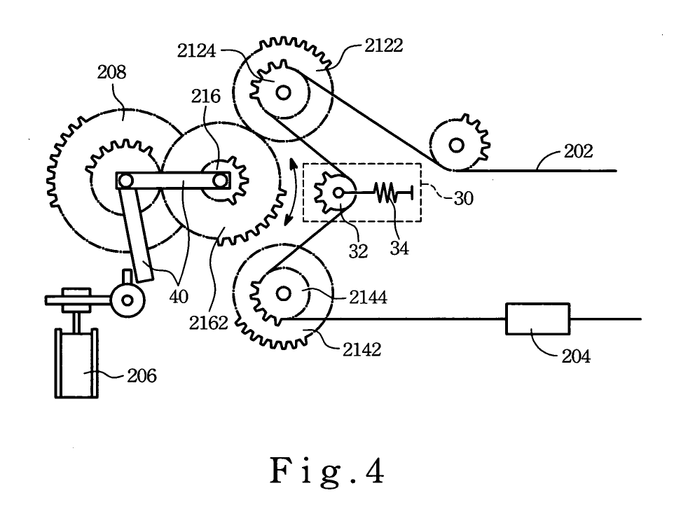

Referring to FIG. 4, the second embodiment of an image scanning apparatus according to the present invention is shown to have the structure similar to previous embodiment. The only difference resides in that a tension adjustment unit 30 is disposed between the first and second gear sets 212, 214 and is operably associated with the toothed belt 202 in order to change tension of the toothed belt 202. The tension adjustment unit 30 includes a tension wheel 32 disposed between the first and second gears 2124, 2144 and a tension spring 34 connected adjustably to the tension wheel 32 in such a manner to bias the tension wheel 32 against the toothed belt 202 for adjusting tension extent of the toothed belt 202. The switch gear unit 216 further includes a swinging arm 40 having a first end carrying rotatably the transmission gear 2162 and a second end carrying rotatably the driving gear 208, and a pushing arm connected pivotally to the driving gear 208 and the output shaft of the stepper motor for moving the transmission gear 2162 between the first and second positions.

Some advantages provided by the scanning apparatus of the present invention as follows:
(i) By using the gear system 210, the problem of insufficient of torque is overcome.
(ii) Little noise is generated during the scanning operation of the image.
(iii) The gear system is simple in construction so that the manufacture cost can be greatly reduced.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A gear system actuated by a driving member via a toothed belt, the gear system comprising:
a first gear set including a first gear adapted to be trained by the toothed belt;
a second gear set spaced apart from said first gear set, and including a second gear adapted to be trained by the toothed belt; and
a switch gear unit including a movable transmission gear that is adapted to be connected operably to the driving member, that is disposed between said first and second gears, and that is movable between a first position, in which said transmission gear meshes with said first gear to provide a first rotation speed of the toothed belt, and a second position, in which said transmission gear meshes with said second gear to provide a second rotation speed of the toothed belt different from said first rotation speed.

2. The gear system according to claim 1, further comprising a tension adjustment unit disposed between said first and second gear sets and operably associated with the toothed belt in order to change tension of the toothed belt.

3. The gear system according to claim 2, wherein said tension adjustment unit includes a tension wheel adapted to be trained by the toothed belt and a tension spring connected adjustably to said tension wheel for adjusting tension extent of the toothed belt.

4. The gear system according to claim 1, wherein the driving member is a stepper motor having an output shaft, said switch gear unit further including a driving gear that is adapted to be coupled co-axially to the output shaft of said stepper motor and that is meshed with said transmission gear.

5. The gear system according to claim 4, wherein said switch gear unit further includes a swinging arm having a first end carrying rotatably said transmission gear and a second end carrying rotatably said driving gear, and a pushing arm connected pivotally to said driving gear and said output shaft of said stepper motor.

6. A scanning apparatus comprising:
a toothed belt;
a scanning module mounted on said toothed belt for co-movable therewith;
a driving member;
a first gear set including a first gear trained by said toothed belt;
a second gear set spaced apart from said first gear set, and including a second gear trained by said toothed belt; and
a switch gear unit including a movable transmission gear driven by said driving member upon actuation thereof, and disposed between said first and second gears and movable between a first position, in which said transmission gear meshes with said first gear to provide a first rotation speed of said toothed belt, and a second position, in which said transmission gear meshes with said second gear to provide a second rotation speed of said toothed belt different from said first rotation speed.

7. The scanning apparatus according to claim 6, further comprising a tension adjustment unit disposed between said first and second gear sets and operably associated with said toothed belt in order to change tension of said toothed belt.

8. The scanning apparatus according to claim 7, wherein said tension adjustment unit includes a tension wheel trained by said toothed belt and a tension spring connected adjustably to said tension wheel for adjusting tension extent of said toothed belt.

9. The scanning apparatus according to claim 7, wherein said driving member is a stepper motor having an output shaft, said switch gear unit further including a driving gear that is coupled co-axially to said output shaft of said stepper motor and that meshes said transmission gear.

10. The scanning apparatus according to claim 9, wherein said switch gear unit further includes a swinging arm having a first end carrying rotatably said transmission gear and a second end carrying rotatably said driving gear, and a pushing arm connected pivotally to said driving gear and said output shaft of said stepper motor.

11. The scanning apparatus according to claim 6, wherein said scanning module includes a charge coupled device (CCD).

12. The scanning apparatus according to claim 6, wherein said scanning module includes a contact image scanner (CIS).

13. The gear system according to claim 4, wherein said switch gear unit further includes a swinging arm having a first end carrying rotatably said transmission gear and a second end carrying rotatably said driving gear, and a pushing arm connected pivotally to said driving gear and said output shaft of said stepper motor.
